(19) United States
(12) Patent Application Publication
(10) Pub. No.: US 2010/0243457 A1
(43) Pub. Date: Sep. 30, 2010

(54) ANODIC OXIDE COATING AND ANODIZING OXIDATION METHOD

(76) Inventors: Masahiro Fujita, Shizuoka-ken (JP); Tomoharu Yamamoto, Shizuoka-ken (JP); Hiroomi Tanaka, Shizuoka-ken (JP)

Correspondence Address: MYERS BIGEL SIBLEY & SAJOVEC, PO BOX 37428, RALEIGH, NC, 27627, US

(21) Appl. No.: 12/728,450

(22) Filed: Mar. 22, 2010

(30) Foreign Application Priority Data
Mar. 31, 2009 (JP) 2009-086503

(51) Int. Cl. B32B 15/04; C25D 11/04

(52) U.S. Cl. 205/50; 205/324

(57) ABSTRACT

An anodic oxide coating has fewer irregularities and has a nonuniform film thickness, and an anodic oxidation method yields the coating. Specifically, an anodic oxidation method of an aluminum or aluminum alloy member applies a voltage to a process component immersed in a processing bath, the process component made of any of aluminum and aluminum alloy members containing at least any of an impurity and an additive. The method includes disposing a pair of negative plates so that the negative plates face the process component; and repeatedly performing a process of applying a positive voltage to the process component and a process of removing charges by using a power supply apparatus including an anodizing direct-current power source, a discharge direct-current power source, a switch configured to connect the process component and the pair of negative plates to any one of terminals of the anodizing direct-current power source and the discharge direct-current power source, the terminals having polarities opposite to each other, and capacitors and regeneration circuits connected to the respective power sources in parallel to the process component and the pair of negative plates.

### CROSS-RELATED APPLICATIONS

This application claims priority from Japanese Patent Application No. 2009-086503; filed Mar. 31, 2009, the disclosure of which is incorporated herein by reference in its entirety.

### BACKGROUND OF THE INVENTION

1. Field of the Invention

The present invention relates to an anodic oxide coating applied on a surface of aluminum or an aluminum alloy and to an anodizing oxidation method for obtaining the coating.

2. Description of Related Art

In a conventional direct-current anodizing process for an aluminum alloy material such as an aluminum cast material (AC material) or an aluminum die-cast material (ADC material), it has been appropriate to immerse the target object in an anodizing fluid (such as a sulfuric acid bath) and to apply a current of 3 A or below per 1 dm² of a surface area of the target object. However, a growth rate of an anodic oxide coating according to this process method is as low as 1.0 μm/min or less for both the AC material and the ADC material. Moreover, the direct-current anodic oxide coating includes a large number of irregularities and thereby has a nonuniform film thickness. Such unevenness has been a major factor in degradation of quality of the coating.

For example, Japanese Patent No. 4075918 (Patent Document 1) discloses an anodizing oxidation method in which a step of applying a positive voltage and a step of removing charges are repeatedly performed on a target object which is immersed in an anodizing fluid. A coating growth rate according to this method is higher than that of the direct-current anodizing oxidation process. To be more precise, this method achieves a growth rate of 7.5 μm/min or higher for an AC material, and a growth rate of 4.0 μm/min or higher for a work surface of an ADC material containing 7.5% or more Si. Moreover, a coating manufactured in accordance with this method is smooth and has a uniform film thickness. Therefore, this coating is superior to the direct-current anodic oxide coating from the viewpoint of the coating quality as well.

Nevertheless, if the growth rate of the coating becomes 13.0 μm/min or higher for the AC material or becomes 6.0 μm/min or higher for the work surface of the ADC material containing 7.5% or more Si, this method has problems in that an anodic oxide coating includes a large number of irregularities and has a nonuniform film thickness, as is the case of the direct-current anodic oxide coating.

### SUMMARY OF THE INVENTION

The present invention is made in view of the above-mentioned circumstances. An object of the present invention is to provide an anodic oxide coating having fewer irregularities and having an uniform film thickness and to provide an anodizing oxidation method for obtaining such a coating.

To address the above object, the present invention provides an anodic oxidation method for an aluminum or aluminum alloy member by applying a voltage to a process component immersed in a processing bath, the process component made of any of aluminum and aluminum alloy members containing at least any of an impurity and an additive. The method includes disposing a pair of negative plates so that the negative plates face the process component; and repeatedly performing a process of applying a positive voltage to the process component and a process of removing charges by using a power supply apparatus. The power supply apparatus includes an anodizing direct-current power source, a discharge direct-current power source, a switch configured to connect the process component and the pair of negative plates to any one of terminals of the anodizing direct-current power source and the discharge direct-current power source, the terminals having polarities opposite to each other, and capacitors and regeneration circuits connected to the respective power sources in parallel to the process component and the pair of negative plates. In the method, a voltage used in the process of removing the charges is controlled to be in a range of −22 to −7 V.

According to the anodic oxidation method of the present invention, it is possible to obtain an anodic oxide coating having fewer irregularities and having a uniform film thickness.

### BRIEF DESCRIPTION OF THE DRAWINGS

FIG. 1 is a schematic diagram of an electrolytic apparatus for implementing an anodic oxidation method of the present invention.

FIG. 2 is a schematic diagram of a modified embodiment of an electrolytic apparatus for implementing the anodic oxidation method of the present invention.

FIG. 3A is a schematic diagram showing another modified embodiment of an electrolytic apparatus for implementing the anodic oxidation method of the present invention, FIG. 3B is a power supply circuit diagram used in this electrolytic apparatus shown in FIG. 3A, and FIG. 3C is a graph showing waveforms of a voltage and a current provided from this power supply circuit.

FIG. 4 is a schematic diagram of another modified embodiment of an electrolytic apparatus for implementing the anodic oxidation method of the present invention.

FIG. 5 is a graph showing a relationship between a coating growth rate and standard deviation of film thickness distribution for a material ADC 12.

FIG. 6 is a graph showing a relationship between a negative voltage and the standard deviation of film thickness distribution for the material ADC 12.

FIG. 7 is a graph showing a relationship between a negative voltage and standard deviation of film thickness distribution for a material AC 8A.

### DETAILED DESCRIPTION OF THE PREFERRED EMBODIMENTS

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

An anodic oxidation method according to the present invention will be described.

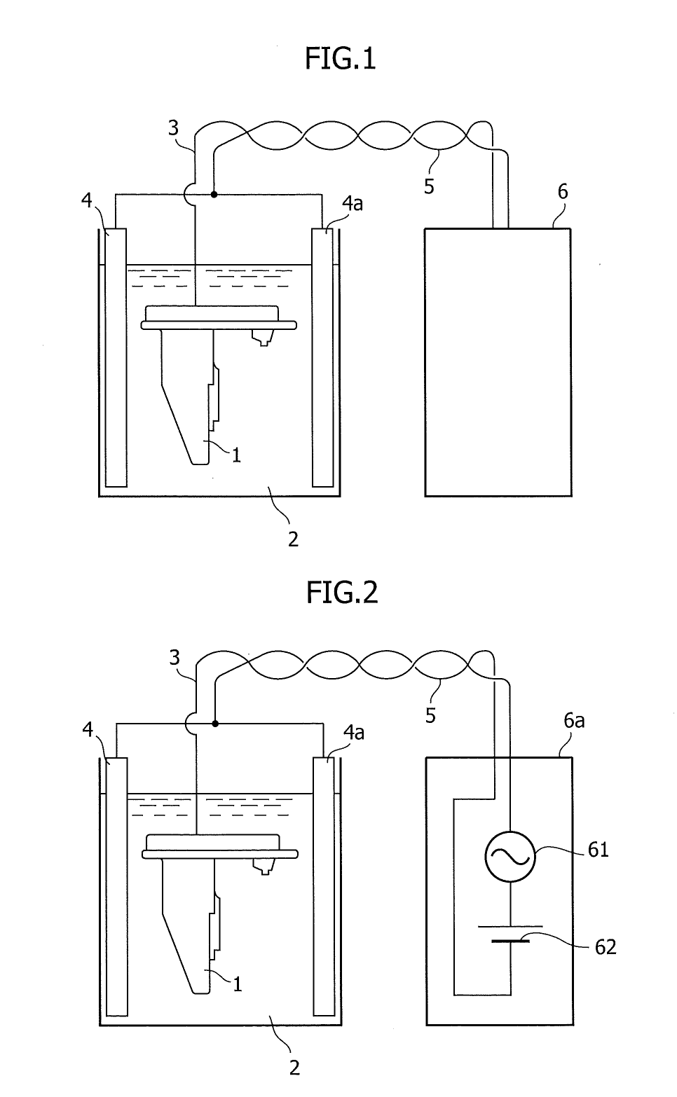

An anodic oxidation method according to an embodiment of the present invention can be implemented by use of an electrolytic apparatus provided with a processing bath and a power source. FIG. 1 shows an example of the electrolytic apparatus to be used in the anodic oxidation method according to this embodiment. The apparatus shown in FIG. 1 includes a processing bath 2, an anode transmission line 3, a pair of negative plates 4 and 4a, a cathode transmission line 5, and a power source 6 and allows a process component 1 mainly made of aluminum or an aluminum alloy member to be attached thereto.

The process component 1 is a target for anodizing. A target object is either aluminum or the aluminum alloy member, Depending on the intended use, the target object may contain additives such as Si, or other impurities, or may contain both the additives and the impurities, or may not contain any of such additives and impurities. The aluminum alloy member may be an aluminum cast material, an aluminum die-cast material, and an aluminum expanded material, for example. Moreover, the shape of such aluminum or an aluminum alloy member may be a plate shape or a bar shape, for example, but is not particularly limited thereto.

The processing bath 2 may be of diluted sulfuric acid, oxalic acid, phosphoric acid, or chromic acid, for example, but is not only limited thereto. The processing bath 2 may employ a processing fluid used for usual anodizing, such as a diprotic acid bath, a mixed bath of a diprotic acid bath and an organic acid, or an alkaline bath. The alkaline bath may contain an alkaline earth metal compound. Alternatively, the alkaline bath may contain a boride or a fluoride selectively as appropriate.

The processing bath 2 includes a mechanism which can perform sufficient stirring. Such a mechanism is provided to prevent a local burn attributable to bubbles and the like generated therein. By sufficiently stirring the processing fluid, it is possible to assist uniform growth of the coating.

The pair of negative plates 4 and 4a is disposed inside the processing bath 2 so as to face each other with the process component 1 placed in the middle. The negative plates 4 and 4a immersed in the processing fluid 2 preferably have a surface area that can be immersed in the processing fluid, which is at least 20 times as large as a surface area of the process component 1. Such a configuration is appropriate for obtaining a uniform coating.

The anode transmission line 3 is configured to connect the process component 1 made of aluminum or the aluminum alloy member to an anode side of the power source 6 while the cathode transmission line 5 is configured to connect the negative plates 4 to the cathode side of the power source 6. The anode transmission line 3 and the cathode transmission line 5 for power transmission respectively to the anode and the cathode may employ a material which can transmit, without causing stresses, a current equal to or above 20 A for 1 dm² of the surface area of the process component 1 and the negative plates 4 and 4b. To be more precise, the transmission lines may employ copper wires, copper plates, and the like.

The power source 6 is configured to supply positive charges to the process component 1 to achieve anodizing in a very short period and to release in a very short period the charges accumulated on the coating during the anodizing. Accordingly, the power source 6 to be used in the electrolytic apparatus preferably has such a function to switch between the application of a positive voltage and the removal of the charges at a high speed.

Next, respective steps of the anodic oxidation method using the apparatus shown in FIG. 1 will be described.

First, in a step of applying the positive voltage, the cathode transmission line 5 is connected to the process component 1 made of aluminum or the aluminum alloy member, and then the process component 1 is immersed into the processing bath 2 and is subjected to an electrolytic process by applying the positive voltage thereto.

In a step of removing charges, application of the positive voltage is temporarily interrupted and then the electrodes are short-circuited or a negative voltage is applied to the electrodes. To be more precise, the short circuit of the electrodes can be performed either by connecting the anode transmission line 3 directly to the cathode transmission line 5 or by bringing the process component 1 into contact with the negative plates 4. Application of the negative voltage is preferable herein because this allows the accumulated charges to flow quickly and thereby to shorten the period required for releasing the charges.

After applying the positive voltage similarly for a short period, application of the positive voltage is interrupted and the accumulated charges are removed again. The process is continued by repeating the above-described steps until the coating reaches a desired thickness. Here, the coating thickness varies depending on the intended use and may be in a range of 5 μm to 50 for example. However, the coating thickness is not limited to this range. In this embodiment, the following method is applied in order to repeat application of the positive voltage and the removal of the charges at a high speed.

For example, it is possible to perform application of the positive voltage and application of the negative voltage alternately by using an alternating-current power source as the power source 6. Meanwhile, it is also possible to switch connections between a connection to a direct-current power source for anodizing at the time of anodizing and a connection to another direct-current power source for discharge at the time of a discharge. In this case, the power source 6 includes a switch configured to switch between the direct-current power source for anodizing and the direct-current power source for discharge at a high speed, and the direct-current power source for anodizing, the direct-current power source for discharge, and the switch collectively constitute an AC/DC dual power source.

An application voltage waveform is not particularly limited and may be a sinusoidal wave, a rectangular wave (pulse wave), a triangular wave, and the like. Moreover, it is preferable that the voltage repeatedly applied be constant because with such a constant voltage, the coating grows uniformly so that it is possible to control the coating thickness by processing time.

Although an appropriate value for application of the positive voltage varies depending on the size of the surface area of the target object, the value may be set for an AC material preferably in a range of about 20 to 150 V or more preferably in a range of about 30 to 100 V, and for an ADC material preferably in a range of about 30 to 150 V or more preferably in a range of about 40 to 100 V.

Application of the positive voltage may be selected within an anodizing range where occurrence of appearance defects such as a burned coating or a melted coating is prevented.

The negative voltage to be applied may be regulated to be in a range of −22 to −7 V. In particular, it is possible to set the voltage for an AC material preferably in a range of about −21 to −7 V, more preferably in a range of about −17 to −11 V, or most preferably in a range of about −16 to −14 V, and for an ADC material preferably in a range of about −22 to −11 V, more preferably in a range of −18 to −13 V, or most preferably in a range of about −16 to −14 V.

As the charges are accumulated between the anodic oxide coating and the aluminum alloy member, the aluminum is melted and oxidized to cause the coating to grow. However, the melting and oxidation of the aluminum is less likely to occur in a portion containing a large amount of an alloy component such as Si and the coating grows less in that portion. Now, the negative voltage is applied to remove the accumulated charges, so that a coating growth occurs more significantly at the thin portion of the coating with another application of the positive voltage. This is because the charges are accumulated at a thin portion of the coating more quickly than at a thick portion of the coating. The film thickness of the coating becomes uniform by repeating in this way the application of the positive voltage for growing the coating and the application of the negative voltage for removing the charges at a very short cycle. Nevertheless, when the coating growth rate is further increased, more charges are accumulated on the coating due to an increased current flowing thereon and the removal of the charges may become insufficient. As a consequence, the coating may include many irregularities and the film thickness becomes non-uniform. On the other hand, if the negative voltage is applied excessively, more negative charges are accumulated at the thin portion of the coating where the charges are easily accumulated and the charges thus accumulated inhibits the growth of the coating (the growth of the coating is inhibited because when the negative charges are accumulated on the coating, the accumulated negative charges need to be removed before the positive voltage is applied to cause an anodic oxidation reaction). Hence the film thickness of the coating becomes non-uniform. Accordingly, application of the optimum negative voltage is important to obtain the coating having the uniform film thickness.

As an example of using an alternating-current power source, FIG. 2 shows an electrolytic apparatus which includes as a constituent an AC/DC dual power source 6a configured to perform an AC/DC dual electrolytic process combining a direct current and an alternating current. The AC/DC dual power source 6a supplies the positive charges to the process component 1 for anodizing in a very short period and causes the charges accumulated on the coating at the time of the anodizing to be released in a very short period. Accordingly, the AC/DC dual power source 6a is suitable for use as the power source for the electrolytic apparatus for implementing the method of the present invention. Particularly, as shown in FIG. 2, the AC/DC dual power source 6a in which an alternating-current power source 61 and a direct-current power source 62 are connected in series to each other is also advantageous in that it is also possible to eliminate surges when the power sources are switched. In this electrolytic apparatus, it is preferable to cause the anode transmission line 3 and the cathode transmission line 5 to entwine around each other or to attach closely to each other with an insulator interposed therebetween in order to prevent a power loss attributable to frequencies.

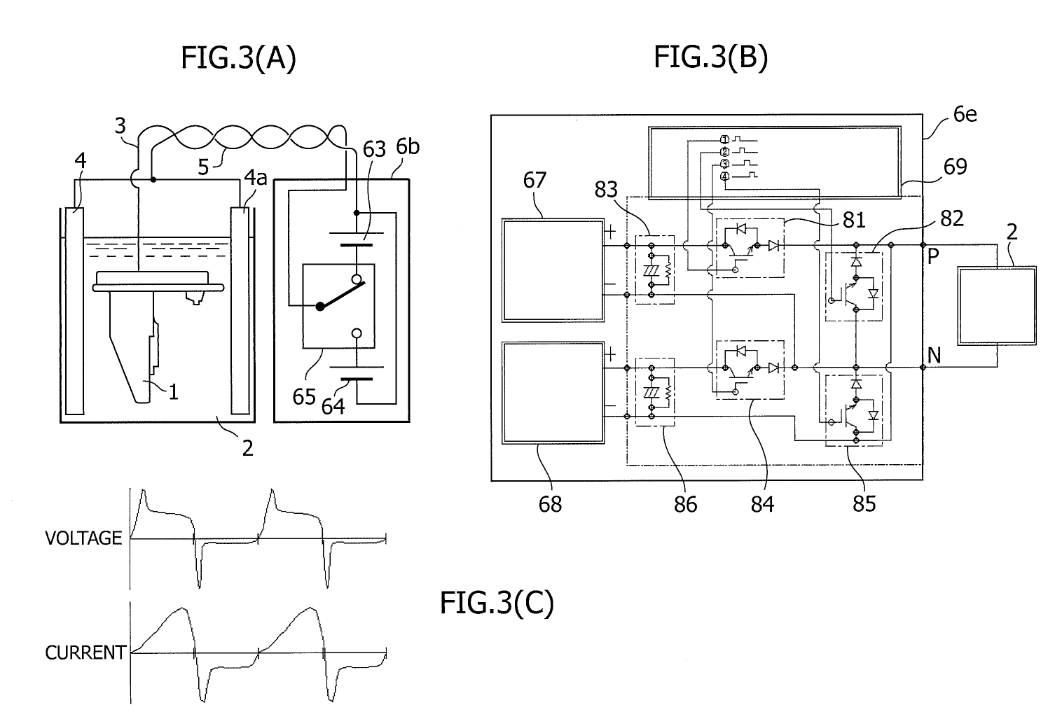

FIG. 3A shows an electrolytic apparatus which includes as a constituent a power source 6b configured to perform a direct-current electrolytic process. This power source 6b includes an anodizing direct-current power source 63, a discharge direct-current power source 64, and a switch 65, and is able to switch between the application of the positive voltage and the removal of the charges by use of the switch 65. As compared to the apparatus shown in FIG. 2, this electrolytic apparatus is advantageous in that it requires a far smaller number of constituents, and thereby its manufacturing process costs less.

FIG. 3B shows a specific power circuit configuration of the apparatus in FIG. 3A. A power source 6e includes an anodizing direct-current power source 67, a discharge direct-current power source 68, and a switch (an inverter) 69, and is able to switch between the application of the positive voltage and the removal of the charges by use of the switch 69. The power source 6b in FIG. 3A corresponds to the power source 6e, the anodizing direct-current power source 63 therein corresponds to the anodizing direct-current power source 67, the discharge direct-current power source 64 corresponds to the discharge direct-current power source 68, and the switch 65 corresponds to the switch 69, respectively. Reference numerals 81, 82, 84, and 85 denote high-speed semiconductor switches, each of which is formed of a power device such as an IGBT or a power MOS-FET.

At the time of anodizing, the switch 81 is turned on, whereby anodizing is performed by use of the charges from the anodizing direct-current power source 67 and a capacitor 83. Next, the switch 81 is turned off while a current is regenerated by turning the switch 82 on, thereby preparing for switching to the discharge direct-current power source 68. This operation also has an effect of providing a time-lag before the switching so that the anodizing direct-current power source 67 and the discharge direct-current power source 68 are not short-circuited. At the time of discharge, the switch 84 is turned on, whereby the charges accumulated on the coating are released by use of the charges from the discharge direct-current power source 68 and a capacitor 86. Next, the switch 84 is turned off while a current is regenerated by turning the switch 85 on, thereby preparing for switching to the anodizing direct-current power source 67. The anodic oxidation process is executed by repeating these operations. In this way, it is possible to obtain voltage and current waveforms as shown in FIG. 3C.

This electrolytic apparatus is the concrete form of the configuration in FIG. 3A, which is advantageous in that it requires a far smaller number of constituents, and thereby its manufacturing process costs less as compared to the apparatus shown in FIG. 2, and in that it is possible to achieve instantaneous switching in the order of microseconds by use of the high-capacity capacitors 83 and 86 as well as the switches 82 and 85 constituting regeneration circuits, thereby reducing an impact due to overcurrent, the capacitors 83 and 86 and the switches 82 and 85 shown in FIG. 3A.

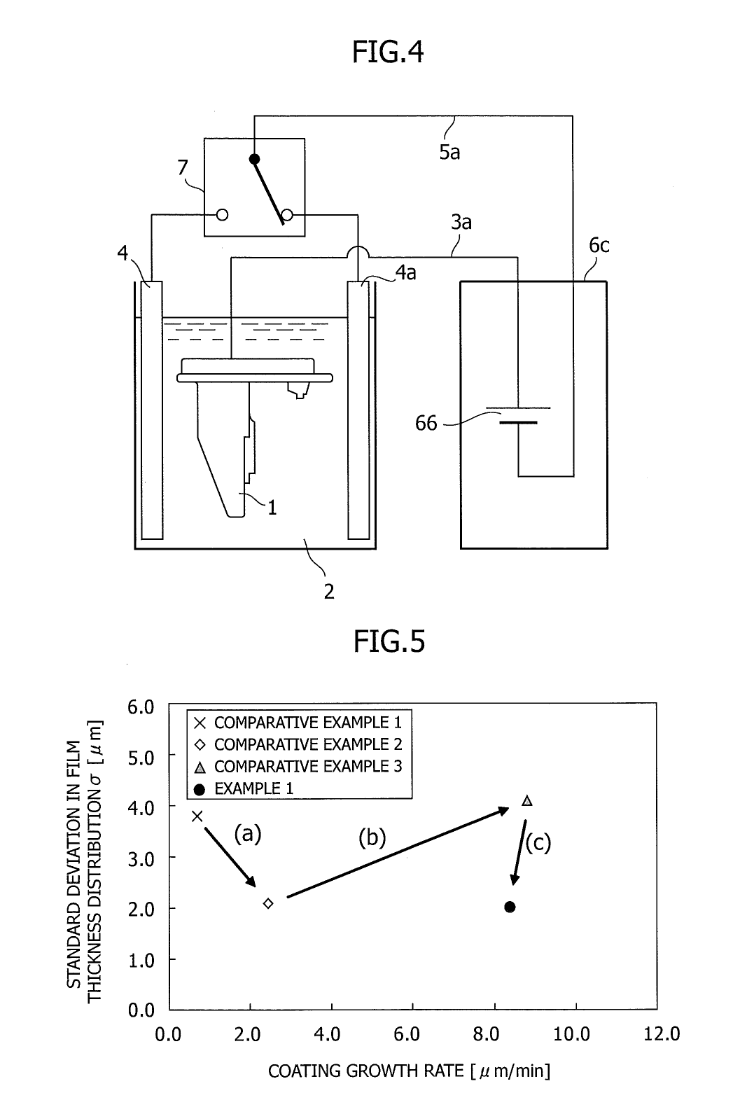

FIG. 4 shows an electrolytic apparatus including, as a constituent, the power source 6c configured to perform the direct-current electrolytic process. The power source 6c includes a direct-current power source 66, two or more pairs of cathodes, and a cathode switching device 7, and achieves the application of the positive voltage and the removal of the charges by means of transfer of the charges on a work. The negative plates 4 and 4a are connected to a cathode transmission line 5a via the switching device 7. The switching device 7 is used to switch current flow between the negative plates 4 and 4b alternately. It is possible to form the anodic oxide coating of the present invention as the charges transfer toward the negative plate 4 or 4a having the current flow. This electrolytic apparatus particularly has an advantage that when the process component 1 is a large component and thus a large current flows during the anodic oxidation process, a large alternating current is kept moving inside the process component 1. As a consequence, a current load is kept low.

When performing application of the positive voltage and application of the negative voltage by use of the alternating-current power source, the AC/DC dual power source or the like, each current flowing time period per application of the positive voltage may be set to be in a range of 25 μs to 500 μs as appropriate for the size of the surface area of the target object.

If application of the positive voltage and application of the negative voltage are repeated at the same time period, then it is preferable to perform the process at a cycle ranging from 50 μs to 1000 μs.

By performing the electrolytic process in which application of the positive voltage and removal of the charges are repeated, it is possible to suppress local growth of the coating and thereby to cause the coating to grow uniformly. Moreover, by adjusting the frequencies of switching between application of the positive voltage and removal of the charges, it is possible to control a growth length of the anodic oxide coating in one direction as well as a branching frequency thereof. This control is needed because the direction of growth may be changed or branched when reapplying the positive voltage after removing the charges. The anodic oxidation method according to the present invention can achieve a coating growth rate for an AC material 13.0 μm/min or more, and a coating growth rate for a work surface of an ADC material containing 7.5% or more Si 6.0 μm/min or more. Hence the coating growth rates are increased to approximately 20 μm/min for the AC material and to approximately 14 μm/min for a work surface of the ADC material containing 7.5% or more Si (see Table 2 and Table 4).

Now, the present invention will be described more in detail by use of examples. It is to be noted, however, that the present invention is not limited only to these examples.

### EXAMPLES

### Method of Evaluating Coating Smoothness

Upon manufacturing anodic coatings by using the anodic oxidation method according to the present invention, several types of anodic oxide coatings are manufactured by applying various negative voltages. Then, the anodic oxide coatings are vertically cut so that cross sections of the coatings are exposed and observed. Using each of the cross-sections, the coating film thicknesses are measured in 30 positions at an interval of about 20 μm so that film thickness distribution is obtained. Each of the coatings is evaluated while a standard deviation of the film thickness distribution is regarded as smoothness. The standard deviation σ of the film thickness distribution is expressed by the following equation 1:

$${σ}^{2} = \frac{1}{n} {\sum }_{i = 1}^{n} {( {x}_{i} - \overline{x} )}^{2} \qquad Equation 1$$

(where n indicates the number of measured positions (30 positions), xᵢ indicates the measured film thickness, and x̅ indicates an average film thickness.)

Specifically, as the standard deviation σ is smaller, the coating has a film thickness less deviated from the average film thickness (the film thickness is uniform) and the coating is smooth. Here, the smoothness of the coating is considered as the standard deviation σ, and an effective range (where the coating is considered to have an uniform film thickness and to be smooth) is defined as “equal to or below a median value between the standard deviation σ of a direct-current anodic oxide coating and a standard deviation σ of a coating according to an anodic oxidation method disclosed in Patent Document 1 (a conventional coating having a uniform film thickness)”.

### Example 1

An aluminum alloy die-cast material ADC12 was subjected to the anodic oxidation process in accordance with the anodic oxidation method of the present invention. The processing bath containing 10%-vol sulfuric acid at 20° C. was prepared. The positive voltage was set to +60 V and a time period for application of the positive voltage was set to 56 μs. Meanwhile, the negative voltage was set to −15 V and a time period for application of the negative voltage was set to 56 μs. The positive voltage and the negative voltage were repeatedly applied for 1 minute until the film thickness of the anodic oxide coating grew to a thickness in a range of 7 to 10 μm. Results of Example 1 are shown in FIG. 5 and Table 1.

### Comparative Example 1

The aluminum alloy die-cast material ADC12 was subjected to the anodic oxidation process in accordance with a conventional direct-current anodic oxide method (Method 1). The processing bath containing 10%-vol sulfuric acid at 20° C. was prepared. The process was executed at a current density of 1.5 A/dm² for 10 minutes until the film thickness of the anodic oxide coating grew to a thickness in a range of 7 to 10 μm. Results of Comparative Example 1 are shown in FIG. 5 and Table 1.

### Comparative Example 2

The aluminum alloy die-cast material ADC12 was subjected to the anodic oxidation process in accordance with the anodic oxidation method disclosed in Patent Document 1 (Method 2). The processing bath containing 10%-vol sulfuric acid at 20° C. was prepared. The positive voltage was set to +45 V and a time period for application of the positive voltage was set to 30 μs. Meanwhile, the negative voltage was set to −2 V and a time period for application of the negative voltage was set to 30 μs. The positive voltage and the negative voltage were repeatedly applied for 4 minutes until the film thickness of the anodic oxide coating grew to a thickness in a range of 7 to 10 Results of Comparative Example 2 are shown in FIG. 5 and Table 1.

### Comparative Example 3

The aluminum alloy die-cast material ADC12 was subjected to the anodic oxidation process in accordance with a method obtained by modifying the anodic oxidation method disclosed in Patent Document 1, the coating growth rate enhanced in the modified method (Method 3). The processing bath containing 10%-vol sulfuric acid at 20° C. was prepared. The positive voltage was set to +60 V and a time period for application of the positive voltage was set to 56 μs. Meanwhile, the negative voltage was set to 0 V and a time period for application of the negative voltage was set to 56 μs. The positive voltage and the negative voltage were repeatedly applied for 1 minute until the film thickness of the anodic oxide coating grew to a thickness in a range of 7 to 10 μm. Results of Comparative Example 3 are shown in FIG. 5 and Table 1.

TABLE 1

| | | | | | Average | Coating | |
|---|---|---|---|---|---|---|---|
| | Voltage Apply | | Positive | Negative | Film | Growth | Standard |
| | Period | Cycle | Voltage | Voltage | Thickness | Rate | Deviation |
| | [μs] | [μs] | [V] | [V] | [μm] | [μm/min] | σ [μm] |
| Example 1 | 56 | 152 | 60 | −15 | 8.4 | 8.4 | 2.0 |
| Comparative | — | — | Current Density | | 7.4 | 0.7 | 3.8 |
| Example 1 | | | 1.5 A/dm² | | | | |
| (Method 1) | | | | | | | |
| Comparative | 30 | 100 | 45 | −2 | 9.7 | 2.4 | 2.1 |
| Example 2 | | | | | | | |
| (Method 2) | | | | | | | |
| Comparative | 56 | 152 | 60 | 0 | 8.8 | 8.8 | 4.1 |
| Example 3 | | | | | | | |
| (Method 3) | | | | | | | |

FIG. 5 and Table 1 show that Comparative Example 1 has a very slow coating growth rate and poor uniformity of the film thickness. However, the coating growth rate and the uniformity of the film thickness are significantly improved in Comparative Example 2 ((a) in FIG. 5). Comparative Example 3 has a coating growth rate further increased relative to Comparative Example 2. As the coating growth rate is increased, the standard deviation of the film thickness distribution is increased, and thereby it is shown that uniformity of the film thickness is degraded ((b) in FIG. 5). In Example 1, the negative voltage was appropriately regulated in order to solve this problem. Example 1 succeeds in obtaining uniformity of the film thickness which is equivalent to that of the coating obtained by Comparative Example 2 while having the coating growth rate equivalent to that of Comparative Example 3 ((c) in FIG. 5).

### Example 2

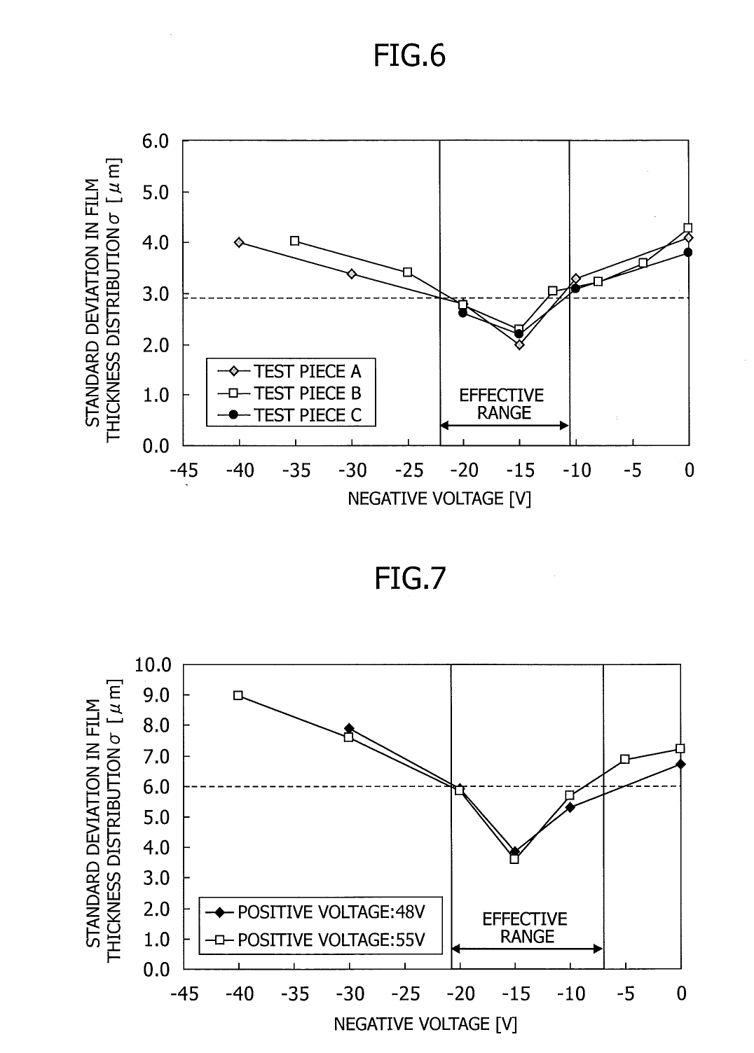

The aluminum alloy die-cast material ADC12 was used as a test piece and the anodic oxidation processes were executed in accordance with Methods 1 to 3, respectively. Method 1 was executed in a similar manner to Comparative Example 1 while Method 2 was executed in a similar manner to Comparative Example 2. Meanwhile, Method 3 was executed in a similar manner to Comparative Example 3 except that various negative voltages were applied. Thereby, uniformity of the film thickness was measured while applying various voltages. Moreover, three different types of test pieces (A, B, and C) having mutually different surface shapes were used for this example. Standard deviations of the film thickness distribution while changing the negative voltages are shown in FIG. 6 and Table 2, and cross-sectional photographic images are shown in Table 3.

TABLE 2

| | | | | | | Average | Coating | |
|---|---|---|---|---|---|---|---|---|
| | | Voltage Apply | | Positive | Negative | Film | Growth | Standard |
| Test | Process | Period | Cycle | Voltage | Voltage | Thickness | Rate | Deviation |
| Piece | Method | [μs] | [μs] | [V] | [V] | [μm] | [μm/min] | σ [μm] |
| A | Method 1 | — | — | Current Density | | 7.4 | 0.7 | 3.8 |
| | | | | 1.5 A/dm² | | | | |
| | Method 2 | 30 | 100 | 45 | −2 | 9.7 | 2.4 | 2.1 |
| | Method 3 | 56 | 152 | 60 | 0 | 8.8 | 8.8 | 4.1 |
| | | 56 | 152 | 60 | −10 | 10.5 | 10.5 | 3.3 |
| | | 56 | 152 | 60 | −15 | 8.4 | 8.4 | 2.0 |
| | | 56 | 152 | 60 | −20 | 10.9 | 10.9 | 2.8 |
| | | 56 | 152 | 60 | −30 | 10.7 | 10.7 | 3.4 |
| | | 56 | 152 | 60 | −40 | 10.3 | 10.3 | 4.0 |
| B | Method 1 | — | — | Current Density | | 11.5 | 0.5 | 4.2 |
| | | | | 2 A/dm² | | | | |
| | Method 2 | 30 | 100 | 45 | −2 | 13.2 | 2.6 | 2.0 |
| | Method 3 | 60 | 160 | 50 | 0 | 12.6 | 12.6 | 4.3 |
| | | 60 | 160 | 50 | −4 | 12.3 | 12.3 | 3.6 |
| | | 60 | 160 | 50 | −8 | 14.0 | 14.0 | 3.2 |
| | | 60 | 160 | 50 | −12 | 12.2 | 12.2 | 3.0 |
| | | 60 | 160 | 50 | −15 | 13.4 | 13.4 | 2.3 |
| | | 60 | 160 | 50 | −20 | 10.6 | 10.6 | 2.8 |
| | | 60 | 160 | 50 | −25 | 11.7 | 11.7 | 3.4 |
| | | 60 | 160 | 50 | −35 | 7.6 | 7.6 | 4.0 |
| C | Method 1 | — | — | Current Density | | 5.4 | 0.5 | 3.5 |
| | | | | 1.5 A/dm² | | | | |
| | Method 2 | 56 | 152 | 55 | −2 | 7.5 | 1.9 | 2.0 |
| | Method 3 | 111 | 262 | 80 | 0 | 7.9 | 7.9 | 3.8 |
| | | 111 | 262 | 80 | −10 | 8.8 | 8.8 | 3.1 |
| | | 111 | 262 | 80 | −15 | 7.3 | 7.3 | 2.2 |
| | | 111 | 262 | 80 | −20 | 7.3 | 7.3 | 2.6 |

* Processed Area of Test Piece A: 2.7 dm²
* Processed Area of Test Piece B: 3.6 dm²
* Processed Area of Test Piece C: 11 dm²

TABLE 3

| | Negative | Standard | |
|---|---|---|---|
| Process | Voltage | Deviation | |
| Method | [V] | σ [μ m] | Cross-Sectional Photographic Image of Coating |
| Method 1 | − | 3.8 | 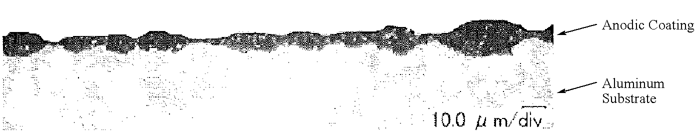 |
| Method 2 | −2 | 2.1 | 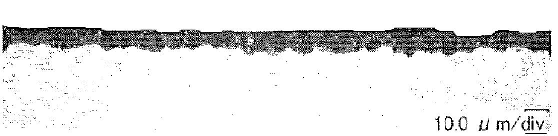 |
| | 0 | 4.1 | 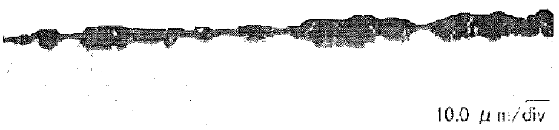 |
| | −10 | 3.3 | 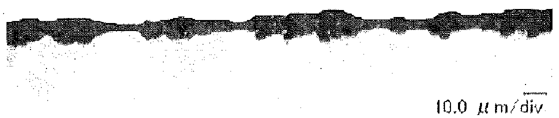 |
| | −15 | 2.0 | 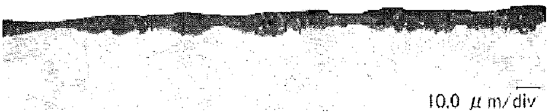 |
| Method 3 | | | |
| | −20 | 2.8 | 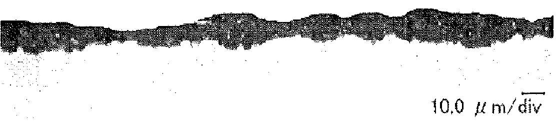 |
| | −30 | 3.4 | 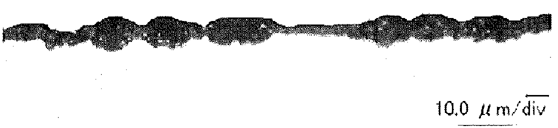 |
| | −40 | 4.0 | 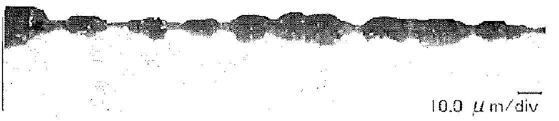 |

FIG. 6, Table 2, and Table 3 show a result that uniformity of the film thickness is improved when the negative voltage is set to be in a range of −22 V to −11 V. In a case in which the applied negative voltage is small (close to 0 V), the charges are removed only insufficiently. On the other hand, in a case in which the applied negative voltage is excessively large, a large amount of negative charges accumulate in a thin portion of the coating where the charges are likely to accumulate, whereby the growth of the coating is inhibited. Such insufficient removal of charges and accumulation of negative charges may be factors for the nonuniform film thickness.

### Example 3

An AC8A material is used as a test piece and the anodic oxidation process is executed in accordance with the methods similar to those in Example 2 to determine an effective range of the negative voltage. One type of the test piece is used therein. Moreover, it was also investigated as to whether or not the optimum range of the negative voltage remains the same while the positive voltage is changed. Standard deviations of the film thickness distribution when changing the negative voltage are shown in FIG. 7 and Table 4.

TABLE 4

| | | | | | Average | Coating | |
|---|---|---|---|---|---|---|---|
| | Voltage Apply | | Positive | Negative | Film | Growth | Standard |
| Process | Period | Cycle | Voltage | Voltage | Thickness | Rate | Deviation |
| Method | [μs] | [μs] | [V] | [V] | [μm] | [μm/min] | σ [μm] |
| Method 1 | — | — | Current Density | | 19.5 | 1.0 | 7.7 |
| | | | 2.5 A/dm² | | | | |
| Method 2 | 30 | 100 | 43 | −2 | 17.0 | 4.3 | 4.3 |
| Method 3 | 60 | 160 | 48 | 0 | 13.7 | 13.7 | 6.7 |
| | 60 | 160 | 48 | −10 | 13.3 | 13.3 | 5.3 |
| | 60 | 160 | 48 | −15 | 14.1 | 14.1 | 3.8 |
| | 60 | 160 | 48 | −20 | 14.3 | 14.3 | 5.9 |
| | 60 | 160 | 48 | −30 | 11.8 | 11.8 | 7.9 |
| | 60 | 160 | 55 | 0 | 19.0 | 19.0 | 7.2 |
| | 60 | 160 | 55 | −5 | 18.7 | 18.7 | 6.9 |
| | 60 | 160 | 55 | −10 | 16.0 | 16.0 | 5.7 |
| | 60 | 160 | 55 | −15 | 19.6 | 19.6 | 3.6 |
| | 60 | 160 | 55 | −20 | 19.6 | 19.6 | 5.9 |
| | 60 | 160 | 55 | −30 | 11.1 | 11.1 | 7.6 |
| | 60 | 160 | 55 | −40 | 14.4 | 14.4 | 9.0 |

FIG. 7 and Table 4 show results that uniformity of the film thickness is improved when the negative voltage is set to be in a range of −21 V to −7 V. Similar to the results of Example 2, in a case in which the applied negative voltage is small (close to 0 V), the charges are removed only insufficiently. On the other hand, in a case in which the applied negative voltage is excessively large, a large amount of negative charges accumulate in a thin portion of the coating where the charges are likely to accumulate, whereby the growth of the coating is inhibited. Such insufficient removal of charges and accumulation of negative charges may be factors for the nonuniform film thickness.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed. The following claims are provided to ensure that the present application meets all statutory requirements as a priority application in all jurisdictions and shall not be construed as setting forth the full scope of the present invention.

What is claimed is:

1. An anodic oxidation method of an aluminum or aluminum alloy member by applying a voltage to a process component immersed in a processing bath, the process component made of any of aluminum and aluminum alloy members containing at least one of an impurity and an additive, the method comprising:
disposing a pair of negative plates so that the negative plates face the process component; and
repeatedly performing a process of applying a positive voltage to the process component and a process of removing charges by using a power supply apparatus including
an anodizing direct-current power source,
a discharge direct-current power source,
a switch configured to connect the process component and the pair of negative plates to any one of terminals of the anodizing direct-current power source and the discharge direct-current power source, the terminals having polarities opposite to each other, and
capacitors and regeneration circuits connected to the respective power sources in parallel to the process component and the pair of negative plates,
wherein a voltage used in the process of removing the charges is regulated to be in a range of −22 to −7 V.

2. The anodic oxidation method according to claim 1,
wherein the aluminum alloy member is any of an aluminum cast material and an aluminum die-cast material.

3. The anodic oxidation method according to claim 1,
wherein the voltage to be applied to the process component made of an aluminum cast material in the step of removing the charges is in a range of −21 V to −7 V.

4. The anodic oxidation method according to claim 1,
wherein the voltage to be applied to the process component made of an aluminum die-cast material in the step of removing the charges is in a range of −22 V to −11 V.

5. An anodic oxide coating formed by the anodic oxidation method according to claim 1.

6. An anodic oxide coating formed by the anodic oxidation method according to claim 2.

7. An anodic oxide coating formed by the anodic oxidation method according to claim 3.

8. An anodic oxide coating formed by the anodic oxidation method according to claim 4.
